(19) United States
(12) Patent Application Publication
(10) Pub. No.: US 2024/0203190 A1
(43) Pub. Date: Jun. 20, 2024

(54) MONEY HANDLING APPARATUS AND MONEY HANDLING METHOD

(71) Applicant: GLORY LTD., Hyogo (JP)

(72) Inventors: Yang CHEN, Hyogo (JP); Kazuhiro DOI, Hyogo (JP); Kenichi TAGASHIRA, Hyogo (JP)

(21) Appl. No.: 18/591,058

(22) Filed: Feb. 29, 2024

Related U.S. Application Data
(63) Continuation of application No. PCT/JP2022/032325, filed on Aug. 29, 2022.

(30) Foreign Application Priority Data
Sep. 3, 2021 (JP) 2021-143962

(51) Int. Cl. G07D 11/34; G07D 11/25; G07D 9/00; G07D 11/13

(52) U.S. Cl. CPC G07D 11/34; G07D 11/25; G07D 9/00; G07D 11/13; G07D 2201/00; G07D 2211/00

(57) ABSTRACT

A money handling apparatus is capable of appropriately performing reconciliation on a first storage unit regardless of a maximum storage amount of the first storage unit without leading to an increase in a size of the apparatus. The apparatus includes a first storage unit storing money and discharging the stored money, a transport unit transporting money, a recognition unit recognizing money, and a control unit performing reconciliation for confirming a storage amount of money in the first storage unit by the recognition unit's recognizing money in the first storage unit, discharged from the first storage unit and transported by the transport unit. The control unit performs the reconciliation when a deemed storage amount that is an amount of money deemed to be stored in the first storage unit satisfies a predetermined condition. The predetermined condition is that the deemed storage amount is less than or equal to an amount of the money allowed to be concurrently positioned in a place other than the first storage unit in the apparatus.

### CROSS REFERENCE TO RELATED APPLICATIONS

The present application claims priority to, and contains subject matter to, PCT/JP2022/032325, filed on Aug. 29, 2022, and JP2021-143962, filed on Sep. 3, 2021, the entire contents of each of which incorporated herein by reference.

### TECHNICAL FIELD

The present disclosure relates to a money handling apparatus and a money handling method.

### BACKGROUND ART

Hitherto, there is known a money handling apparatus that handles deposit and withdrawal of coins. An existing money handling apparatus is configured to allow a coin storage cassette to be detached and attached. When such a money handling apparatus performs reconciliation on the coin storage cassette, the money handling apparatus discharges all the coins in the coin storage cassette to a transport path, recognizes the coins with a coin recognition unit, and returns the coins to the coin storage cassette again.

### SUMMARY

A money handling apparatus according to the present disclosure includes a first storage unit that stores money and discharges the stored money, a transport unit that transports money, a recognition unit that recognizes money, and a control unit that performs reconciliation for confirming a storage amount of money in the first storage unit by the recognition unit's recognizing money that is discharged from the first storage unit and transported by the transport unit. The control unit performs the reconciliation when a deemed storage amount that is an amount of money deemed to be stored in the first storage unit satisfies a predetermined condition. The predetermined condition is that the deemed storage amount is less than or equal to an amount of the money allowed to be concurrently positioned in a place other than the first storage unit in the money handling apparatus.

### BRIEF DESCRIPTION OF DRAWINGS

FIG. 1 is a block diagram of a money handling apparatus according to Embodiment 1;

FIG. 2 is a block diagram of a money handling apparatus according to Embodiment 2;

FIG. 3 is a block diagram of a money handling apparatus according to Embodiment 3;

FIG. 4 is a schematic diagram of the internal configuration of a coin handling apparatus according to Embodiment 4;

FIG. 5A is a diagram illustrating first reconciliation according to Embodiment 4;

FIG. 5B is a diagram illustrating second reconciliation according to Embodiment 4;

FIG. 6 is a flowchart of reconciliation according to Embodiment 4;

FIG. 7 is a flowchart of reconciliation according to Embodiment 4 subsequent to FIG. 6; and

FIG. 8 is a schematic diagram of the internal configuration of a banknote handling apparatus according to Embodiment 5.

### DESCRIPTION OF EMBODIMENTS

In reconciliation that is performed in the money handling apparatus described in Japanese Patent Application Laid-open No. 2004-326542, before coins discharged from the coin storage cassette and recognized by the coin recognition unit return to the coin storage cassette again, all the coins in the coin storage cassette need to be discharged to the transport path. For this reason, the maximum storage amount (capacity) of the coin storage cassette needs to be less than or equal to the number of coins allowed to be concurrently transported by the transport path. On the other hand, to remove such limitations on the maximum storage amount of the coin storage cassette, it is conceivable to increase the number of coins allowed to be concurrently transported by the transport path. In this case, the size of the money handling apparatus needs to be increased.

The present disclosure provides a money handling apparatus and a money handling method capable of appropriately performing reconciliation on the first storage unit regardless of the maximum storage amount of the first storage unit without leading to an increase in the size of the money handling apparatus.

A money handling apparatus according to the present disclosure includes: a first storage unit that stores money and discharges the stored money; a transport unit that transports money; a recognition unit that recognizes money; and a control unit that performs reconciliation for confirming a storage amount of money in the first storage unit by the recognition unit recognizing money that is discharged from the first storage unit and transported by the transport unit, in which the control unit performs the reconciliation when a deemed storage amount that is an amount of money deemed to be stored in the first storage unit satisfies a predetermined condition, and the predetermined condition is that the deemed storage amount is less than or equal to an amount of the money allowed to be concurrently positioned in a place other than the first storage unit in the money handling apparatus.

In the money handling apparatus according to the present disclosure, the transport unit may include a transport path that transports the money, and a feeding unit that temporarily holds a plurality of pieces of money and feeds out the held pieces of money one by one.

In the money handling apparatus according to the present disclosure, the predetermined condition may be that the deemed storage amount is less than or equal to an amount of money allowed to be concurrently supported by the transport unit.

In the money handling apparatus according to the present disclosure, the control unit may control the transport unit such that the money recognized by the recognition unit is returned to the first storage unit during performing the reconciliation.

The money handling apparatus according to the present disclosure may further include a second storage unit that stores the money recognized by the recognition unit, in which the control unit may control the transport unit such that the money is transported to the second storage unit, when the money recognized by the recognition unit is target money to be stored in the second storage unit during performing the reconciliation.

In the money handling apparatus according to the present disclosure, the second storage unit may include a plurality of denomination-specific storage units that stores the money by denomination, and the control unit may control the transport unit such that the money recognized by the recognition unit is transported to the denomination-specific storage unit corresponding to the denomination of the money.

In the money handling apparatus according to the present disclosure, the predetermined condition may be that the deemed storage amount is less than or equal to an amount of money allowed to be stored in the second storage unit at time of determining whether the deemed storage amount satisfies the predetermined condition.

In the money handling apparatus according to the present disclosure, the predetermined condition may be that the deemed storage amount is less than or equal to a total amount of an amount of money allowed to be concurrently supported by the transport unit and an amount of money allowed to be stored in the second storage unit at time of determining whether the deemed storage amount satisfies the predetermined condition.

In the money handling apparatus according to the present disclosure, the control unit may control the transport unit such that the money recognized by the recognition unit is returned to the first storage unit, when the money recognized by the recognition unit is not allowed to be stored in the second storage unit.

In the money handling apparatus according to the present disclosure, the control unit may determine that the reconciliation has been terminated in an uncompleted state, when the money recognized by the recognition unit has returned to the first storage unit before all the money in the first storage unit is discharged.

The money handling apparatus according to the present disclosure may further include a notification unit that notifies that the deemed storage amount satisfies the predetermined condition.

The money handling apparatus according to the present disclosure may further include an input unit that allows entry of an instruction for starting the reconciliation, in which the control unit may start the reconciliation when the control unit receives the instruction from the input unit.

In the money handling apparatus according to the present disclosure, the control unit may determine whether the deemed storage amount satisfies the predetermined condition, based on a denomination of the money stored in the first storage unit.

A money handling method according to the present disclosure is a method that is executed by a money handling apparatus including a first storage unit that stores money and discharges the stored money, and a recognition unit that recognizes money, the money handling method including: performing, by the money handling apparatus, reconciliation for confirming a storage amount of money in the first storage unit by recognizing money discharged from the first storage unit with the recognition unit, when a deemed storage amount that is an amount of money deemed to be stored in the first storage unit satisfies a predetermined condition, in which the predetermined condition is that the deemed storage amount is less than or equal to an amount of the money allowed to be concurrently positioned in a place other than the first storage unit in the money handling apparatus.

With the money handling apparatus and the money handling method according to the present disclosure, it is possible to appropriately perform reconciliation on the first storage unit regardless of the maximum storage amount of the first storage unit without leading to an increase in the size of the money handling apparatus.

### Embodiment 1

Embodiment 1 will be described with reference to the attached drawings.

### Configuration of Money Handling Apparatus

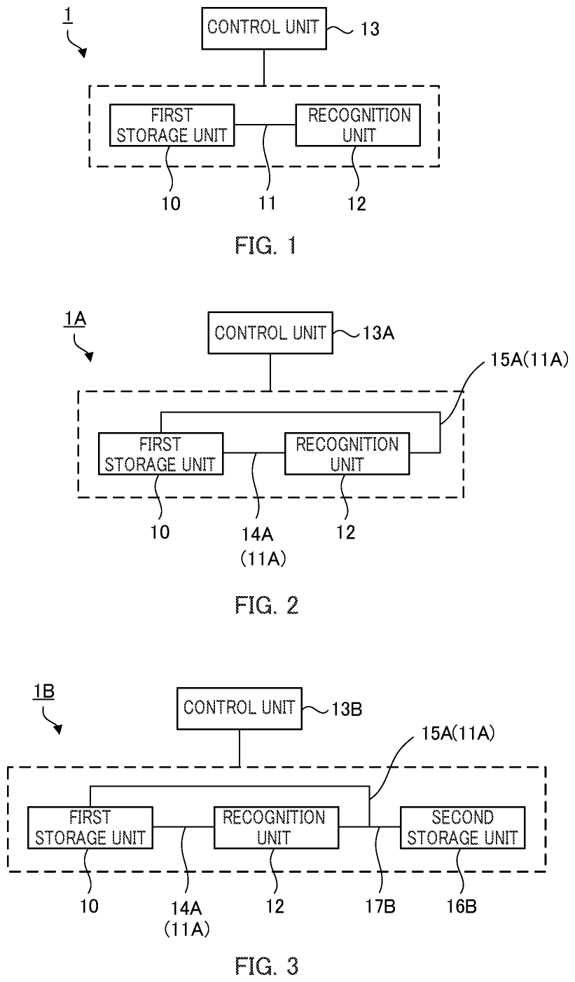

Initially, the configuration of the money handling apparatus will be described. FIG. 1 is a block diagram of the money handling apparatus. In the specification, the amount of money, coins, or banknotes means the ones allowed to be used for comparison in magnitude on money, coins, or banknotes and is, for example, number, mass, or volume. When a single piece of money, for example, one Euro coin is handled in the money handling apparatus, the value can also be included in the amount of coins.

The money handling apparatus 1 shown in FIG. 1 handles money. Handling on money is, for example, settlement at a shop. Handling on money may be handling accompanied by deposit and withdrawal, other than settlement. Money that is handled by the money handling apparatus 1 may be coins and may be banknotes. The money handling apparatus 1 includes a first storage unit 10, a transport unit 11, a recognition unit 12, and a control unit 13.

The first storage unit 10 stores money. The first storage unit 10 has a mechanism of discharging money stored in the first storage unit 10. For example, a recycling storage unit for storing money used for settlement, an overflow storage unit for storing money that cannot be stored in the recycling storage unit because the recycling storage unit is full, a refilling storage unit for refilling the recycling storage unit with money, or the like may be applied as the first storage unit 10. A storage unit that functions as an overflow storage unit and a refilling storage unit may be applied as the first storage unit 10. Money in the first storage unit 10 increases or decreases as a result of, for example, settlement, manual loading by a clerk, or the like. Information indicating a deemed storage amount of the first storage unit 10 may be stored in a memory unit of the money handling apparatus 1 or may be stored in a management apparatus that stores and manages information on the money handling apparatus 1. A deemed storage amount of the first storage unit 10 is the amount of money deemed to be stored in the first storage unit 10. Information indicating a deemed storage amount of the first storage unit 10 may be updated based on a recognition result of the recognition unit 12, may be updated by a clerk performing input operation to an input unit, or may be updated based on a detection result of a sensor.

The transport unit 11 transports money in the first storage unit 10. The transport unit 11 separates pieces of money and transports the pieces of money one by one.

The recognition unit 12 recognizes, for example, the denomination, authenticity, fitness, and the like of money that is transported by the transport unit 11 and counts the money.

The control unit 13 controls the transport unit 11 such that reconciliation for confirming a storage amount of money in the first storage unit 10 by the recognition unit 12's recognizing money in the first storage unit 10 is performed. The control unit 13 performs reconciliation on the first storage unit 10 when the deemed storage amount of the first storage unit 10 satisfies a predetermined condition. The predetermined condition according to Embodiment 1 is that the deemed storage amount of the first storage unit 10 is less than or equal to the amount of money allowed to be concurrently positioned in a place other than the first storage unit 10 in the money handling apparatus 1 when reconciliation is performed. The control unit 13 may acquire, from the memory unit or the management apparatus, information indicating the deemed storage amount of the first storage unit 10 and the predetermined condition. When the control unit 13 performs reconciliation, the control unit 13 controls the transport unit 11 such that all the money in the first storage unit 10 is transported to the recognition unit 12 one by one. The control unit 13 confirms the storage amount of money in the first storage unit 10 based on the recognition result of the recognition unit 12. The control unit 13 causes the memory unit to store the reconciliation result or causes the management apparatus to send the reconciliation result.

### Operation of Money Handling Apparatus

Next, the operation of the money handling apparatus 1 will be described.

The control unit 13 determines whether the deemed storage amount of the first storage unit 10 satisfies the predetermined condition. For example, every set time interval, time when set time comes, time when a clerk issues instructions, or time when a situation in which it is not possible to confirm an inventory amount (the storage amount of money) of the first storage unit 10 may be illustrated as timing to perform the determination. When the control unit 13 determines that the deemed storage amount of the first storage unit 10 satisfies the predetermined condition, the control unit 13 performs reconciliation on the first storage unit 10. On the other hand, when the control unit 13 determines that the deemed storage amount of the first storage unit 10 does not satisfy the predetermined condition, the control unit 13 does not perform reconciliation on the first storage unit 10. Even when the deemed storage amount of the first storage unit 10 satisfies the predetermined condition, the control unit 13 does not need to start reconciliation until the control unit 13 receives instructions for starting the reconciliation from the input unit based on input operation of a clerk.

In this way, the money handling apparatus 1 performs reconciliation only when the deemed storage amount of the first storage unit 10 satisfies the predetermined condition. For this reason, regardless of the maximum storage amount of the first storage unit 10, the money handling apparatus 1 is capable of concurrently positioning all the money stored in the first storage unit 10 in a place other than the first storage unit 10. Therefore, it is possible to prevent mixture of money recognized by the recognition unit 12 (hereinafter, which may be referred to as “recognized money”) and money not yet recognized by the recognition unit 12 (hereinafter, which may be referred to as “not-yet-recognized money”) in the first storage unit 10. Even when the number of pieces of money allowed to be concurrently transported by the transport unit 11 is not increased to remove limitations on the maximum storage amount of the first storage unit 10, it is possible to prevent mixture of recognized money and not-yet-recognized money in the first storage unit 10 at the time of reconciliation. For this reason, the size of the money handling apparatus 1 does not need to be increased. Therefore, the money handling apparatus 1 is capable of appropriately performing reconciliation on the first storage unit 10 regardless of the maximum storage amount of the first storage unit 10 without leading to an increase in the size of the money handling apparatus 1.

### Embodiment 2

Next, Embodiment 2 will be described with reference to the attached drawings.

### Configuration of Money Handling Apparatus

Initially, the configuration of a money handling apparatus will be described. FIG. 2 is a block diagram of the money handling apparatus. The same names and the same reference signs denote components similar to those of the money handling apparatus 1 according to Embodiment 1, and the description is simplified or omitted.

The money handling apparatus 1A shown in FIG. 2 includes the first storage unit 10, a transport unit 11A, the recognition unit 12, and a control unit 13A. The transport unit 11A includes a first transport unit 14A and a second transport unit 15A. The first transport unit 14A transports all the not-yet-recognized money in the first storage unit 10 to the recognition unit 12. The second transport unit 15A transports the recognized money to the first storage unit 10. The first transport unit 14A and the second transport unit 15A separate pieces of money and transport the pieces of money one by one.

The control unit 13A performs reconciliation on the first storage unit 10 when the deemed storage amount of the first storage unit 10 satisfies a predetermined condition. When the control unit 13A performs reconciliation, the control unit 13A controls the first transport unit 14A such that the not-yet-recognized money in the first storage unit 10 is transported to the recognition unit 12 one by one. The control unit 13A confirms the storage amount of money in the first storage unit 10 based on a recognition result of the recognition unit 12. The control unit 13A controls the second transport unit 15A such that the recognized money is returned to the first storage unit 10.

The predetermined condition according to Embodiment 2 is that the deemed storage amount of the first storage unit 10 is less than or equal to the amount of (supportable amount) of money allowed to be concurrently supported by the transport unit 11A at the time of transporting money (that is, allowed to be concurrently positioned at the transport unit 11A). In other words, the predetermined condition is that the deemed storage amount of the first storage unit 10 is less than or equal to a total amount of a supportable amount of not-yet-recognized money by the first transport unit 14A and a supportable amount of recognized money by the second transport unit 15A. When the deemed storage amount of the first storage unit 10 is the number of pieces of money, the supportable amount of the transport unit 11A may be the number of pieces of money allowed to be concurrently supported by the transport unit 11A at the time of transporting money. When the deemed storage amount of the first storage unit 10 is the mass of money, the supportable amount of the transport unit 11A may be a total value of mass of money allowed to be concurrently supported by the transport unit 11A at the time of transporting money. When the deemed storage amount of the first storage unit 10 is the volume of money, the supportable amount of the transport unit 11A may be a total value of volume of money allowed to be concurrently supported by the transport unit 11A at the time of transporting money.

### Operation of Money Handling Apparatus

Next, the operation of the money handling apparatus 1A will be described.

The control unit 13A determines, for example, at the timing illustrated in Embodiment 1, whether the deemed storage amount of the first storage unit 10 satisfies the predetermined condition. When the control unit 13A determines that the deemed storage amount of the first storage unit 10 satisfies the predetermined condition, the control unit 13A performs reconciliation on the first storage unit 10. On the other hand, when the control unit 13A determines that the deemed storage amount of the first storage unit 10 does not satisfy the predetermined condition, the control unit 13A does not perform reconciliation on the first storage unit 10. Even when the deemed storage amount of the first storage unit 10 satisfies the predetermined condition, the control unit 13A does not need to start reconciliation until the control unit 13A receives instructions for starting reconciliation from an input unit based on input operation of a clerk.

Here, when the deemed storage amount of the first storage unit 10 satisfies the predetermined condition, the transport unit 11A is capable of concurrently supporting (transporting) all the money stored in the first storage unit 10 as recognized money or not-yet-recognized money. Therefore, even when reconciliation is performed in a case where the deemed storage amount of the first storage unit 10 satisfies the predetermined condition, recognized money and not-yet-recognized money do not mix in the first storage unit 10. On the other hand, when the deemed storage amount of the first storage unit 10 does not satisfy the predetermined condition, the transport unit 11A is not capable of concurrently supporting (transporting) all the money stored in the first storage unit 10 as recognized money or not-yet-recognized money. Therefore, when reconciliation is performed in a case where the deemed storage amount of the first storage unit 10 does not satisfy the predetermined condition, recognized money returns to the first storage unit 10 in a state where not-yet-recognized money remains in the first storage unit 10, so recognized money and not-yet-recognized money mix in the first storage unit 10.

As described above, since the money handling apparatus 1A performs reconciliation only when the deemed storage amount of the first storage unit 10 satisfies the predetermined condition, it is possible to prevent mixture of recognized money and not-yet-recognized money in the first storage unit 10 regardless of the maximum storage amount of the first storage unit 10. Even when the number of pieces of money allowed to be concurrently transported by the transport unit 11A is not increased to remove limitations on the maximum storage amount of the first storage unit 10, it is possible to prevent mixture of recognized money and not-yet-recognized money in the first storage unit 10 at the time of reconciliation. For this reason, the size of the money handling apparatus 1A does not need to be increased. Therefore, the money handling apparatus 1A is capable of appropriately performing reconciliation on the first storage unit 10 regardless of the maximum storage amount of the first storage unit 10 without leading to an increase in the size of the money handling apparatus 1A.

### Embodiment 3

Next, Embodiment 3 will be described with reference to the attached drawings.

### Configuration of Money Handling Apparatus

Initially, the configuration of a money handling apparatus will be described. FIG. 3 is a block diagram of the money handling apparatus. The same names and the same reference signs denote components similar to those of the money handling apparatus 1 according to Embodiment 1 and those of the money handling apparatus 1A according to Embodiment 2, and the description is simplified or omitted.

The money handling apparatus 1B shown in FIG. 3 includes the first storage unit 10, a second storage unit 16B, the transport unit 11A, a transport unit 17B for the second storage unit, the recognition unit 12, and a control unit 13B.

The second storage unit 16B stores money. The second storage unit 16B has a mechanism of discharging money stored in the second storage unit 16B. For example, a recycling storage unit, a denomination-specific storage unit for storing money used for settlement by denomination, or the like may be applied as the second storage unit 16B. Money in the second storage unit 16B increases or decreases as a result of, for example, settlement, or the like. Information indicating a deemed storage amount of the second storage unit 16B (the amount of money deemed to be stored in the second storage unit 16B) may be stored in a memory unit or may be stored in a management apparatus of the money handling apparatus 1B. Information indicating a deemed storage amount of the second storage unit 16B may be updated based on a recognition result of the recognition unit 12, may be updated by a clerk performing input operation to an input unit, or may be updated based on a detection result of a sensor.

The transport unit 17B for the second storage unit is diverged from a middle part of the second transport unit 15A. The transport unit 17B for the second storage unit transports recognized money intended to be transported to the transport unit 17B for the second storage unit, to the second storage unit 16B.

The control unit 13B performs reconciliation on the first storage unit 10 when the deemed storage amount of the first storage unit 10 satisfies a predetermined condition. When the control unit 13B performs reconciliation, the control unit 13B controls the first transport unit 14A such that the not-yet-recognized money in the first storage unit 10 is transported to the recognition unit 12 one by one. The control unit 13B confirms the storage amount of money in the first storage unit 10 based on the recognition result of the recognition unit 12. The control unit 13B controls the second transport unit 15A and the transport unit 17B for the second storage unit such that recognized money is transported to the first storage unit 10 or the second storage unit 16B based on the recognition result of the recognition unit 12. For example, the control unit 13B controls the second transport unit 15A and the transport unit 17B for the second storage unit such that recognized money is transported to the second storage unit 16B until the second storage unit 16B becomes full and, after the second storage unit 16B becomes full, recognized money is transported to the first storage unit 10.

The predetermined condition according to Embodiment 3 may be that the deemed storage amount of the first storage unit 10 is less than or equal to the supportable amount of the transport unit 11A. The predetermined condition may be that the deemed storage amount of the first storage unit 10 is less than or equal to the amount of money allowed to be stored (storable amount) in the second storage unit 16B at the time of determining whether the deemed storage amount of the first storage unit 10 satisfies the predetermined condition. The storable amount of the second storage unit 16B may be calculated by subtracting the deemed storage amount of the second storage unit 16B from the maximum storage amount of the second storage unit 16B. The predetermined condition may be that the deemed storage amount of the first storage unit 10 is less than or equal to a total amount of the supportable amount of the transport unit 11A and the storable amount of the second storage unit 16B. As in the case of Embodiment 2, the deemed storage amount of the first storage unit 10, the supportable amount of the transport unit 11A, and the storable amount of the second storage unit 16B may be expressed by the number of pieces of money, the mass of money, or the volume of money.

### Operation of Money Handling Apparatus

Next, the operation of the money handling apparatus 1B will be described. Hereinafter, the case where the predetermined condition is that the deemed storage amount of the first storage unit 10 is less than or equal to a total amount of the supportable amount of the transport unit 11A and the storable amount of the second storage unit 16B will be described. When the predetermined condition is that the deemed storage amount of the first storage unit 10 is less than or equal to the supportable amount of the transport unit 11A or less than or equal to the storable amount of the second storage unit 16B as well, the money handling apparatus 1B performs handling similar to that in the following description.

The control unit 13B determines, for example, at the timing illustrated in Embodiment 1, whether the deemed storage amount of the first storage unit 10 satisfies the predetermined condition. When the control unit 13B determines that the deemed storage amount of the first storage unit 10 satisfies the predetermined condition, the control unit 13B performs reconciliation on the first storage unit 10. On the other hand, when the control unit 13B determines that the deemed storage amount of the first storage unit 10 does not satisfy the predetermined condition, the control unit 13B does not perform reconciliation on the first storage unit 10. Even when the deemed storage amount of the first storage unit 10 satisfies the predetermined condition, the control unit 13B does not need to start reconciliation until the control unit 13B receives instructions for starting reconciliation from the input unit based on input operation of a clerk.

Here, when the deemed storage amount of the first storage unit 10 satisfies the predetermined condition, the transport unit 11A is capable of concurrently supporting (transporting) recognized money or not-yet-recognized money in a state where the first storage unit 10 is empty even when the second storage unit 16B is full as a result of transporting recognized money to the second storage unit 16B. Therefore, even when reconciliation is performed in a case where the deemed storage amount of the first storage unit 10 satisfies the predetermined condition, recognized money and not-yet-recognized money do not mix in the first storage unit 10. On the other hand, when the deemed storage amount of the first storage unit 10 does not satisfy the predetermined condition, the transport unit 11A is not capable of concurrently supporting (transporting) recognized money or not-yet-recognized money in a state where the first storage unit 10 is empty after the second storage unit 16B becomes full. Therefore, when reconciliation is performed in a case where the deemed storage amount of the first storage unit 10 does not satisfy the predetermined condition, recognized money returns to the first storage unit 10 in a state where not-yet-recognized money remains in the first storage unit 10, so recognized money and not-yet-recognized money mix in the first storage unit 10.

As described above, since the money handling apparatus 1B performs reconciliation only when the deemed storage amount of the first storage unit 10 satisfies the predetermined condition, it is possible to prevent mixture of recognized money and not-yet-recognized money in the first storage unit 10 regardless of the maximum storage amount of the first storage unit 10. Even when the number of pieces of money allowed to be concurrently transported by the transport unit 11A is not increased to remove limitations on the maximum storage amount of the first storage unit 10, it is possible to prevent mixture of recognized money and not-yet-recognized money in the first storage unit 10 at the time of reconciliation. For this reason, the size of the money handling apparatus 1B does not need to be increased. Therefore, the money handling apparatus 1B is capable of appropriately performing reconciliation on the first storage unit 10 regardless of the maximum storage amount of the first storage unit 10 without leading to an increase in the size of the money handling apparatus 1B.

### Embodiment 4

Next, Embodiment 4 will be described with reference to the attached drawings. In Embodiment 4, a coin handling apparatus that is an example of the money handling apparatus will be described. For example, the coin handling apparatus is used as a settlement machine that is installed at a shop.

### Configuration of Coin Handling Apparatus

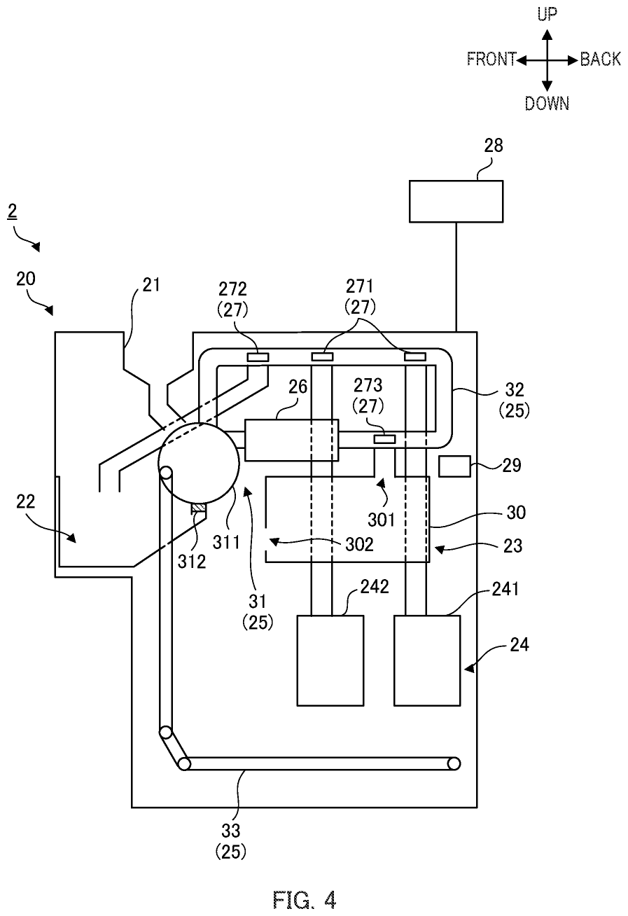

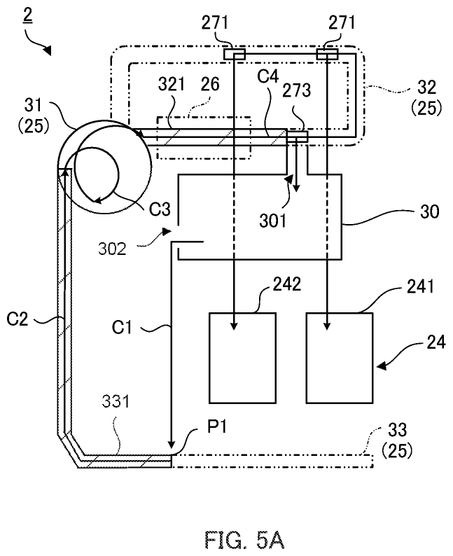

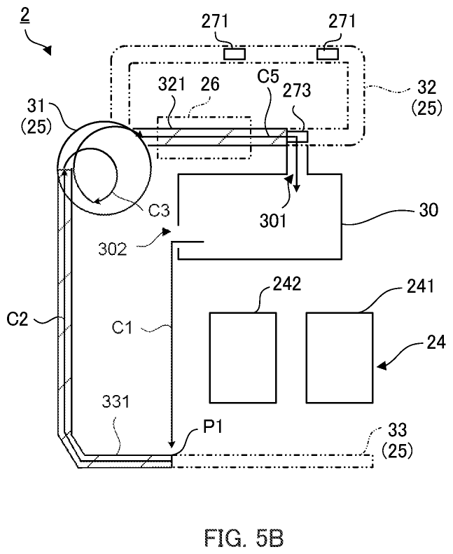

Initially, the configuration of the coin handling apparatus will be described. FIG. 4 is a schematic diagram of the internal configuration of the coin handling apparatus. FIG. 5A is a diagram illustrating first reconciliation. FIG. 5B is a diagram illustrating second reconciliation. In the following description, a front side is a side to which a clerk or a customer of a shop, in which the coin handling apparatus is installed, faces, and a back side is a side opposite to the front side. A right-hand side is a right-hand side when viewed from the clerk or the customer, and a left-hand side is a side opposite to the right-hand side. An upper side is an upper side when viewed from the clerk or the customer, and a lower side is a side opposite to the upper side.

The coin handling apparatus 2 shown in FIG. 4 performs handling on coins that are an example of money. For example, deposit, withdrawal, and reconciliation can be illustrated as handling on coins. The coin handling apparatus 2 includes a casing 20, a deposit unit 21, a withdrawal unit 22, an attachment unit 23, a recycling storage unit 24, a transport unit 25, a recognition unit 26, a plurality of chutes 27, an operation display unit 28, and a control unit 29.

The deposit unit 21 is provided in front of a top face part of the casing 20. The deposit unit 21 is configured to allow coins to be deposited into the coin handling apparatus 2. The withdrawal unit 22 is provided at an upper side on a front face part of the casing 20. The withdrawal unit 22 is configured to allow coins to be withdrawn from the coin handling apparatus 2.

A cassette 30 is detachably attached to the attachment unit 23. The cassette 30 is an example of the first storage unit according to the present disclosure. The attachment unit 23 is hidden by a cover when the cassette 30 is not attached and is exposed when the cover is open. The cassette 30 includes a receiving inlet 301 for storing coins into the cassette 30, a discharge outlet 302 for discharging coins in the cassette 30, an open-close door, and a connector. The cassette 30 may further include a cassette transport unit for transporting coins in the cassette 30 to the discharge outlet 302. The cassette 30 is configured so that a clerk is able to open the open-close door and manually put (manually load) coins into the cassette 30. When a clerk attaches the cassette 30 to the attachment unit 23, a connector of the cassette 30 is connected to a connector of the attachment unit 23, with the result that the control unit 29 is enabled to control the cassette 30.

Coins for refilling the recycling storage unit 24 with change fund are stored in the cassette 30. When a first denomination-specific storage unit 241 and a second denomination-specific storage unit 242 (described later) of the recycling storage unit 24 are full, coins that cannot be fed into the first denomination-specific storage unit 241 or the second denomination-specific storage unit 242 are stored in the cassette 30 as overflow coins. In other words, the cassette 30 functions as a refilling storage unit and an overflow storage unit. Coins in the cassette 30 increase or decrease as a result of, for example, settlement or refilling of change fund. Coins in the cassette 30 increase or decrease as a result of manual loading or collection of coins by a clerk. Coins in the cassette 30 increase or decrease as a result of loading and collection of coins by a loading apparatus. Information indicating a deemed storage amount of the cassette 30 (that is, the amount of coins deemed to be stored in the cassette 30) is stored in a management apparatus that manages the coin handling apparatus 2. Information indicating the deemed storage amount of the cassette 30 may be stored in a memory unit of the coin handling apparatus 2. Information indicating the deemed storage amount of the cassette 30 is updated based on input operation to the operation display unit 28 by a clerk, a detection result of a sensor provided for the cassette 30, or a loading result or collection result of coins in the loading apparatus.

The recycling storage unit 24 is an example of the second storage unit according to the present disclosure. The recycling storage unit 24 includes a plurality of (two in Embodiment 4) denomination-specific storage units 241, 242 (hereinafter, which may be referred to as the first denomination-specific storage unit 241 and the second denomination-specific storage unit 242). The first denomination-specific storage unit 241 and the second denomination-specific storage unit 242 are configured to be capable of storing coins and feeding out the stored coins. Information on a deemed storage amount of the first denomination-specific storage unit 241 and a deemed storage amount of the second denomination-specific storage unit 242 (that is, the amount of coins deemed to be stored in the first denomination-specific storage unit 241 and the amount of coins deemed to be stored in the second denomination-specific storage unit 242) is stored in the management apparatus. Information indicating the deemed storage amount of the recycling storage unit 24 may be stored in the memory unit of the coin handling apparatus 2. Information indicating the deemed storage amount of the first denomination-specific storage unit 241 and the deemed storage amount of the second denomination-specific storage unit 242 is updated based on, for example, a detection result of a sensor provided for the first denomination-specific storage unit 241 and a detection result of a sensor provided for the second denomination-specific storage unit 242. A denomination of coins stored in the first denomination-specific storage unit 241 and a denomination of coins stored in the second denomination-specific storage unit 242 are set in advance. In the following description, a denomination of coins stored in the first denomination-specific storage unit 241 may be referred to as “first denomination”, and a denomination of coins stored in the second denomination-specific storage unit 242 may be referred to as “second denomination”.

The transport unit 25 includes a feeding unit 31, a deposit transport path 32, and a withdrawal transport path 33.

The feeding unit 31 is configured to be capable of receiving coins deposited from the deposit unit 21 and feeding out the coins one by one or dropping the coins to the withdrawal unit 22. The feeding unit 31 includes a hopper 311 that temporarily holds a plurality of coins and a feeding mechanism that feeds out coins in the hopper 311 one by one. For example, a mechanism of using a rotary disk that rotates in an inclined state and picking up and feeding out coins one by one with a plurality of protruding members in an outer region of the surface of the rotary disk may be illustrated as the feeding mechanism.

The deposit transport path 32 transports coins fed out from the feeding unit 31. The deposit transport path 32 separates coins and transports the coins one by one. The deposit transport path 32 is configured as a loop shape to be capable of transporting coins to the back side and then returning the coins to the feeding unit 31. The deposit transport path 32 is made up of a combination of, for example, rollers, a belt wound around the rollers, a motor for driving the rollers, side walls, and the like.

The withdrawal transport path 33 is provided below the feeding unit 31. The withdrawal transport path 33 transports coins, fed out from the first denomination-specific storage unit 241 and the second denomination-specific storage unit 242, to the feeding unit 31. The withdrawal transport path 33 transports coins, discharged and dropped from the cassette 30, to the feeding unit 31.

The recognition unit 26 is provided in the deposit transport path 32. The recognition unit 26 recognizes the denomination, authenticity, fitness, and the like of coins to be transported by the deposit transport path 32 and counts the coins separately by denomination. The recognition unit 26 includes, for example, at least one of an image sensor, an optical sensor, and a magnetic sensor. The recognition unit 26 determines the denomination, authenticity, fitness, and the like of coins and counts the coins separately by denomination based on information acquired by the sensor.

The plurality of chutes 27 is provided downstream of the recognition unit 26 in the deposit transport path 32 in a coin transport direction. The plurality of chutes 27 is provided so as to be lined in the coin transport direction. Two chutes 271 of the plurality of chutes 27 are configured to be capable of respectively guiding coins to the first denomination-specific storage unit 241 and the second denomination-specific storage unit 242. Another chute 272 is configured to be capable of guiding coins to the withdrawal unit 22. A remaining one chute 273 is configured to be capable of guiding coins to the cassette 30. Each of the chutes 27 is normally closed by a gate and guides coins to the units by opening the gate.

The operation display unit 28 is a touch panel display apparatus. The operation display unit 28 functions as an operation unit for inputting information on coin handling in the coin handling apparatus 2 and a display unit that displays information on coin handling. The operation display unit 28 may be configured separately from the coin handling apparatus 2 or may be configured integrally with the coin handling apparatus 2. The operation display unit 28 may be configured such that the operation unit and the display unit are provided independently of each other.

The control unit 29 controls the overall operation of the coin handling apparatus 2. The control unit 29 is, for example, circuitry or processing circuitry which includes general purpose processors, special purpose processors, integrated circuits, ASICs (“Application Specific Integrated Circuits”), conventional circuitry and/or combinations thereof. The control unit 29 controls deposit of coins a customer pays at the time of settlement of goods. When the control unit 29 controls deposit, the control unit 29, for example, controls the feeding unit 31 and the deposit transport path 32 such that coins received from the deposit unit 21 and dropped to the hopper 311 are fed out and transported one by one. The denomination, authenticity, fitness, and the like of coins to be transported are recognized by the recognition unit 26. The control unit 29 controls the deposit transport path 32 and the gates based on a recognition result in the recognition unit 26 such that coins not allowed to be deposited are discharged from the withdrawal unit 22 as rejected coins. The control unit 29 controls the deposit transport path 32 and the chutes 27 such that coins allowed to be deposited are stored in the first denomination-specific storage unit 241 and the second denomination-specific storage unit 242 separately by denomination. When the first denomination-specific storage unit 241 and the second denomination-specific storage unit 242 are full, the control unit 29 controls the deposit transport path 32 and the chutes 27 such that overflow coins are stored in the cassette 30.

The control unit 29 controls withdrawal of coins at the time of settlement of goods. When the control unit 29 controls withdrawal, the control unit 29, for example, controls the first denomination-specific storage unit 241, the second denomination-specific storage unit 242, and the withdrawal transport path 33 such that coins fed out from the first denomination-specific storage unit 241 and the second denomination-specific storage unit 242, storing coins intended for withdrawal, and dropped are transported to the hopper 311 one by one. The control unit 29 controls the feeding unit 31 such that coins are discharged to the withdrawal unit 22 by opening a bottom part 312 of the hopper 311.

The control unit 29 executes control for refilling the recycling storage unit 24 with coins stored in the cassette 30 while a shop is open. The control unit 29 may execute control for initially refilling the recycling storage unit 24 with coins stored in the cassette 30 as change fund, for example, before a shop opens.

For example, in a situation in which it is not possible to confirm the inventory amount of the cassette 30, the control unit 29 performs reconciliation for confirming the inventory amount of the cassette 30 by the recognition unit 26 recognizing coins in the cassette 30. For example, a situation in which a jam of coins occurs or a situation in which the cassette 30 is detached from the attachment unit 23 and attached again can be illustrated as the situation in which it is not possible to confirm the inventory amount of the cassette 30. The control unit 29 is capable of performing first reconciliation shown in FIG. 5A or second reconciliation shown in FIG. 5B.

The first reconciliation is handling in which, while reconciliation on the cassette 30 is being performed, some of recognized coins (coins recognized by the recognition unit 26) are stored as change fund in the recycling storage unit 24 (the first denomination-specific storage unit 241 and the second denomination-specific storage unit 242).

In the first reconciliation, the control unit 29 controls the cassette 30 such that not-yet-recognized coins (coins not recognized by the recognition unit 26) in the cassette 30 are dropped from the discharge outlet 302 as indicated by the arrow C1 in FIG. 5A by opening the receiving inlet 301 and the discharge outlet 302. The control unit 29 controls the withdrawal transport path 33 such that not-yet-recognized coins are transported to the feeding unit 31 one by one as indicated by the arrow C2. The control unit 29 controls the feeding unit 31 such that a plurality of not-yet-recognized coins is temporarily held by the hopper 311 and the not-yet-recognized coins held by the hopper 311 are fed out to the deposit transport path 32 one by one as indicated by the arrow C3. The control unit 29 controls the deposit transport path 32 and the chutes 271, 273 such that, as indicated by the arrow C4, lined not-yet-recognized coins are transported backward to be recognized by the recognition unit 26 and recognized coins are transported to the cassette 30, the first denomination-specific storage unit 241, or the second denomination-specific storage unit 242 based on the recognition result. At this time, the control unit 29 controls the deposit transport path 32 and the chutes 271 such that recognized coins intended to be stored in the first denomination-specific storage unit 241 and the second denomination-specific storage unit 242 are transported to the first denomination-specific storage unit 241 and the second denomination-specific storage unit 242 until the first denomination-specific storage unit 241 and the second denomination-specific storage unit 242 become full. When the first denomination-specific storage unit 241 and the second denomination-specific storage unit 242 are full, the control unit 29 controls the deposit transport path 32 and the chute 273 such that recognized coins are returned to the cassette 30. Then, the control unit 29 confirms the inventory amount of the cassette 30 based on the recognition result by the recognition unit 26. In this way, in the first reconciliation, reconciliation on the first storage unit 10 and refilling the recycling storage unit 24 with change fund are concurrently performed.

On the other hand, the second reconciliation is handling in which reconciliation on the cassette 30 is performed, all the recognized coins are returned to the cassette 30, and recognized coins are not stored in the recycling storage unit 24 (the first denomination-specific storage unit 241 and the second denomination-specific storage unit 242).

In the second reconciliation, the control unit 29, as in the case of the first reconciliation, controls the cassette 30, the withdrawal transport path 33, and the feeding unit 31 such that not-yet-recognized coins in the cassette 30 are transported as indicated by the arrows C1, C2, C3 in FIG. 5B. The control unit 29 controls the deposit transport path 32 and the chute 273 such that, as indicated by the arrow C5, lined not-yet-recognized coins are transported backward and recognized by the recognition unit 26 and recognized coins are transported to the cassette 30. Then, the control unit 29 confirms the inventory amount of the cassette 30 based on a recognition result by the recognition unit 26. In this way, in the second reconciliation, only reconciliation on the first storage unit 10 is performed.

### Operation of Coin Handling Apparatus

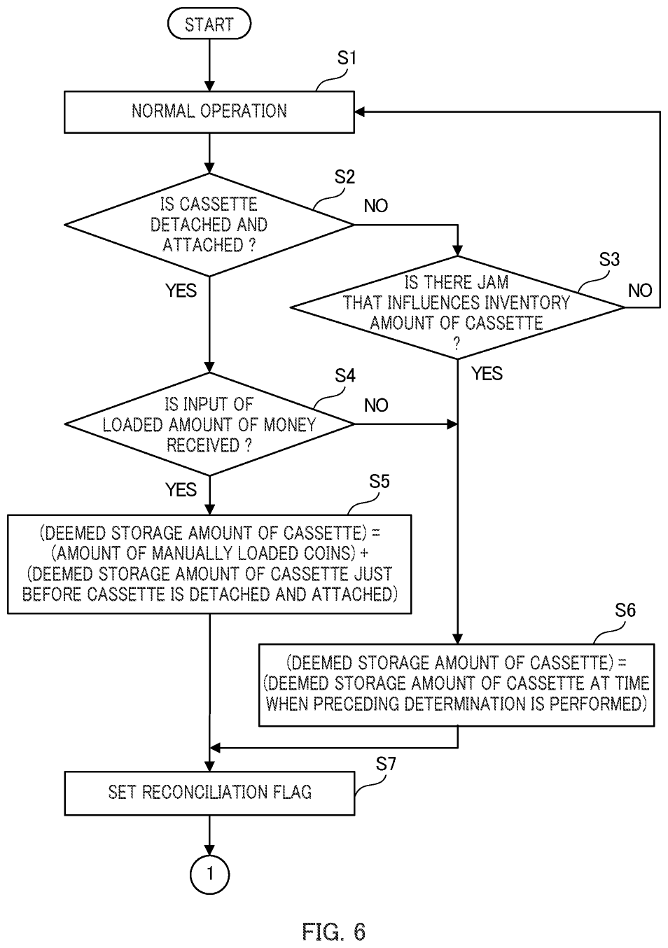

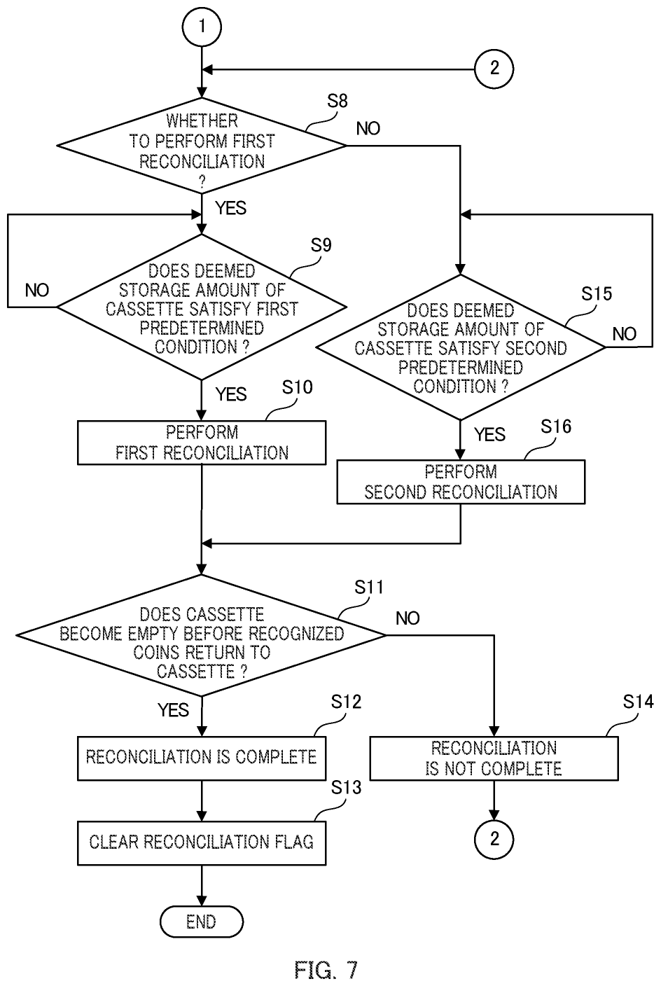

Next, reconciliation in a case where there occurs a situation in which it is not possible to confirm the inventory amount of the cassette 30 will be described as the operation of the coin handling apparatus 2. FIGS. 6 and 7 are flowcharts of reconciliation.

As shown in FIG. 6, the control unit 29 performs handling based on normal operation (step S1). For example, deposit and withdrawal involved in settlement of goods and refilling of change fund can be illustrated as handling based on normal operation in step S1. The control unit 29 determines whether the cassette 30 is detached from the attachment unit 23 and is attached to the attachment unit 23 based on, for example, a connection status between the connector of the cassette 30 and the connector of the attachment unit 23 (step S2).

When the control unit 29 determines that the cassette 30 is not detached and attached (step S2: NO), the control unit 29 determines whether there occurs a jam that influences the inventory amount of the cassette 30 (step S3). Specifically, in step S3, the control unit 29 determines whether there occurs a jam of coins to be transported to the cassette 30 during deposit or a jam of coins discharged from the cassette 30. When the control unit 29 determines that there is no jam that influences the inventory amount of the cassette 30 (step S3: NO), the control unit 29 performs handling based on normal operation (step S1).

On the other hand, when the control unit 29 determines that the cassette 30 is detached and attached (step S2: YES), the control unit 29 determines whether input of a loaded amount of money by a clerk is received (step S4). The input of loaded amount of money is performed at the time when the clerk manually loads the cassette 30 with coins (that is, coins are manually loaded). The clerk inputs the denomination and number of coins as a loaded amount of money with the operation display unit 28. When the clerk inputs a loaded amount of money, the deemed storage amount of the cassette 30, stored in the management apparatus, is updated to a value to which the loaded amount of money input by the clerk is added.

When the control unit 29 determines that input of a loaded amount of money is received (step S4: YES), the amount of coins, obtained by adding the amount of coins manually loaded and the deemed storage amount of the cassette 30 just before the cassette 30 is detached and attached is acquired from the management apparatus as the deemed storage amount of the cassette 30 (step S5).

On the other hand, when the control unit 29 determines that there occurs a jam that influences the inventory amount of the cassette 30 (step S3: YES) or when the control unit 29 determines that input of a loaded amount of money is not received (step S4: NO), the deemed storage amount of the cassette 30 at the time when preceding determination (step S3 or step S4) is performed is acquired from the management apparatus as the deemed storage amount of the cassette 30 (step S6). The control unit 29 sets a reconciliation flag after the process of step S5 or step S6 (step S7).

After the process of step S7, the control unit 29 determines whether to perform first reconciliation, that is, whether to store coins of the cassette 30 in the recycling storage unit 24 (the first denomination-specific storage unit 241 and the second denomination-specific storage unit 242) at the time of reconciliation, as shown in FIG. 7 (step S8). Setting to perform first reconciliation or second reconciliation may be performed based on manual setting operation, for example, at the time of shipment of the coin handling apparatus 2, at the time of installation of the coin handling apparatus 2 to a shop, or at the time of opening of business. When the control unit 29 determines to perform first reconciliation (step S8: YES), the control unit 29 determines whether the deemed storage amount of the cassette 30 satisfies a first predetermined condition (step S9).

The first predetermined condition is that the deemed storage amount of the cassette 30 is less than or equal to the amount of coins allowed to be concurrently positioned in a place other than the cassette 30 at the time of performing first reconciliation.

For example, the first predetermined condition according to Embodiment 4 may be that the deemed storage amount of the cassette 30 is less than or equal to the supportable amount of the transport unit 25 (Condition A). The supportable amount of the transport unit 25 may be the amount of coins allowed to be concurrently supported in the transport unit 25 without mixing recognized coins and not-yet-recognized coins in the cassette 30. For example, the supportable amount of the transport unit 25 may be the amount of coins allowed to be concurrently supported in a first part path 331 surrounded by the continuous line and hatched in FIG. 5A in the withdrawal transport path 33 and a second part path 321 surrounded by the continuous line and hatched in FIG. 5A in the deposit transport path 32 (Condition A1). The first part path 331 is a part from a dropped position (transport start position) P1 of not-yet-recognized coins discharged from the cassette 30 to the feeding unit 31. The second part path 321 is a part from a transport start position of not-yet-recognized coins fed out from the feeding unit 31 to the chute 273 leading to the cassette 30. The supportable amount of the transport unit 25 may be the amount of coins allowed to be held in the feeding unit 31 (Condition A2). Furthermore, the supportable amount of the transport unit 25 may be a total amount of the amount of coins of Condition A1 and the amount of coins of Condition A2 (Condition A3).

For example, the first predetermined condition may be that, at the time of determining whether the first predetermined condition is satisfied, the deemed storage amount of the cassette 30 is less than or equal to the amount of money allowed to be stored in the first denomination-specific storage unit 241 and the second denomination-specific storage unit 242 (storable amount) (Condition B). The storable amount of the first denomination-specific storage unit 241 may be calculated by subtracting the deemed storage amount of the first denomination-specific storage unit 241 from the maximum storage amount of the first denomination-specific storage unit 241. The storable amount of the second denomination-specific storage unit 242 may be calculated by subtracting the deemed storage amount of the second denomination-specific storage unit 242 from the maximum storage amount of the second denomination-specific storage unit 242.

For example, the first predetermined condition may be that the deemed storage amount of the cassette 30 is less than or equal to a total amount of the supportable amount of the transport unit 25 (the amount of coins of any one of Conditions A1 to A3) and the storable amount of the first denomination-specific storage unit 241 and the second denomination-specific storage unit 242 (Condition C).

Setting of applying any one of Condition A (any one of the positions of Conditions A1 to A3), Condition B, and Condition C as the first predetermined condition may be performed based on manual setting operation, for example, at the time of shipment of the coin handling apparatus 2, at the time of installation of the coin handling apparatus 2 to a shop, or at the time of opening of business.

When the control unit 29 determines that the deemed storage amount of the cassette 30 does not satisfy the first predetermined condition (step S9: NO), the control unit 29 executes the process of step S9 after a lapse of a predetermined time. Here, even when it is once determined that the deemed storage amount of the cassette 30 does not satisfy the first predetermined condition, the deemed storage amount of the cassette 30 can satisfy the first predetermined condition thereafter. This is the case where, for example, the deemed storage amount of the cassette 30 reduces as a result of refilling of change fund or the storable amount of the first denomination-specific storage unit 241 and the second denomination-specific storage unit 242 increases as a result of withdrawal. To address such a situation, when the control unit 29 determines in step S9 that the deemed storage amount of the cassette 30 does not satisfy the first predetermined condition, the control unit 29 executes the process of step S9 again after a lapse of a predetermined time.

On the other hand, when the control unit 29 determines that the deemed storage amount of the cassette 30 satisfies the first predetermined condition (step S9: YES), the control unit 29 performs first reconciliation (step S10). After that, the control unit 29 determines whether the cassette 30 becomes empty before recognized coins return to the cassette 30 (step S11).

First reconciliation is performed only when the deemed storage amount of the cassette 30 satisfies the first predetermined condition. For this reason, basically, recognized coins do not return to the cassette 30 before the cassette 30 becomes empty. When, for example, coins stored in the cassette 30 are of one denomination (for example, the first denomination), recognized coins do not return to the cassette 30 before the cassette 30 becomes empty.

However, when, for example, there is a typing error of a loaded amount of money in step S6 and, therefore, the actual storage amount of coins in the cassette 30 does not satisfy the first predetermined condition, that is, when the deemed storage amount of the cassette 30 is not correct, recognized coins return to the cassette 30 before the cassette 30 becomes empty.

Even when the actual storage amount of coins in the cassette 30 satisfies the first predetermined condition, recognized coins can return to the cassette 30 before the cassette 30 becomes empty, depending on the order of coins that are discharged from the cassette 30. For example, a case where the supportable amount of the transport unit 25 is 50 regardless of the denomination of coins, the storable amount of each of the first denomination-specific storage unit 241 and the second denomination-specific storage unit 242 is 50, and 75 of each of coins of the first denomination and coins of the second denomination is stored in the cassette 30 will be discussed. In this case, the deemed storage amount of the cassette 30 satisfies the first predetermined condition (for example, Condition A). Then, when first reconciliation is performed, recognized coins do not return to the cassette 30 before the cassette 30 becomes empty when, for example, the remaining coins of the first denomination are not recognized by the recognition unit 26 until the second denomination-specific storage unit 242 becomes full after the first denomination-specific storage unit 241 becomes full. When the remaining coins of the first denomination are recognized by the recognition unit 26 in a period from when the first denomination-specific storage unit 241 becomes full to when the second denomination-specific storage unit 242 becomes full, coins of the first denomination return to the cassette 30 before the cassette 30 becomes empty.

If recognized coins return to the cassette 30 before the cassette 30 becomes empty, recognized coins and not-yet-recognized coins mix in the cassette 30, and it is not possible to confirm the inventory amount of the cassette 30. In a case of a situation in which recognized coins and not-yet-recognized coins are mixed in the cassette 30, the control unit 29 determines in step S11 whether the cassette 30 becomes empty before recognized coins return to the cassette 30 in order to terminate first reconciliation in an uncompleted state.

When the control unit 29 determines that the cassette 30 becomes empty before recognized coins return to the cassette 30 (step S11: YES), the control unit 29 determines that first reconciliation is complete (step S12). Then, the control unit 29 terminates first reconciliation and stores the reconciliation result in the management apparatus. The control unit 29 clears the reconciliation flag (step S13).

On the other hand, when the control unit 29 determines that the cassette 30 does not become empty before recognized coins return to the cassette 30 (step S11: NO), that is, when recognized coins and not-yet-recognized coins mix in the cassette 30, the control unit 29 determines that first reconciliation is not complete (step S14). In this case, the control unit 29 may cause coins on the transport unit 25 and coins in the first denomination-specific storage unit 241 and the second denomination-specific storage unit 242 to return to the cassette 30 such that the deemed storage amount of the cassette 30 is equal to a deemed storage amount before first reconciliation is started. Then, the control unit 29, for example, executes the process of step S8 for determining whether to perform first reconciliation after a lapse of a predetermined time.

When the control unit 29 determines not to perform first reconciliation (step S8: NO), that is, when the control unit 29 determines to perform second reconciliation, the control unit 29 determines whether the deemed storage amount of the cassette 30 satisfies the second predetermined condition (step S15).

The second predetermined condition is that the deemed storage amount of the cassette 30 is less than or equal to the amount of coins allowed to be concurrently positioned in a place other than the cassette 30 at the time of performing second reconciliation.

For example, the second predetermined condition according to Embodiment 4 may be that the deemed storage amount of the cassette 30 is less than or equal to the supportable amount of the transport unit 25 (Condition A described above). The supportable amount of the transport unit 25 is any one of the amount of coins of Condition A1 (the amount allowed to be concurrently supported on the first part path 331 and the second part path 321), the amount of coins of Condition A2 (the amount of coins allowed to be held in the feeding unit 31), and the amount of coins of Condition A3 (a total amount of the amount of coins of Condition A1 and the amount of coins of Condition A2), described above.

Setting of applying any one of Conditions A1 to A3 as the second predetermined condition may be performed based on manual setting operation, for example, at the time of shipment of the coin handling apparatus 2, at the time of installation of the coin handling apparatus 2 to a shop, or at the time of opening of business.

When the control unit 29 determines that the deemed storage amount of the cassette 30 does not satisfy the second predetermined condition (step S15: NO), the control unit 29 determines again whether the deemed storage amount of the cassette 30 satisfies the second predetermined condition after a lapse of a predetermined time (step S15). Here, even when it is once determined that the deemed storage amount does not satisfy the second predetermined condition, the deemed storage amount can satisfy the second predetermined condition thereafter. This is the case where, for example, the deemed storage amount of the cassette 30 reduces as a result of refilling of change fund or the storable amount of the first denomination-specific storage unit 241 and the second denomination-specific storage unit 242 increases as a result of withdrawal. To address such a situation, when the control unit 29 determines in step S15 that the deemed storage amount of the cassette 30 does not satisfy the second predetermined condition, the control unit 29 executes the process of step S15 again after a lapse of a predetermined time.

On the other hand, when the control unit 29 determines that the deemed storage amount of the cassette 30 satisfies the second predetermined condition (step S15: YES), the control unit 29 performs second reconciliation (step S16). After that, the control unit 29 determines whether the cassette 30 becomes empty before recognized coins return to the cassette 30 (step S11).

Second reconciliation is performed only when the deemed storage amount of the cassette 30 satisfies the second predetermined condition. For this reason, basically, recognized coins do not return to the cassette 30 before the cassette 30 becomes empty.

However, when, for example, there is a typing error of a loaded amount of money in step S6 and, therefore, the actual storage amount of coins in the cassette 30 does not satisfy the second predetermined condition, that is, when the deemed storage amount of the cassette 30 is not correct, recognized coins return to the cassette 30 before the cassette 30 becomes empty.

As described above, when recognized coins return to the cassette 30 before the cassette 30 becomes empty, it is not possible to confirm the inventory amount of the cassette 30. In a case of a situation in which recognized coins and not-yet-recognized coins are mixed in the cassette 30, the control unit 29 determines in step S11 whether the cassette 30 becomes empty before recognized coins return to the cassette 30 in order to terminate second reconciliation in an uncompleted state. After that, the control unit 29 executes the processes of step S12 to step S16 described above. When the control unit 29 determines in step S14 that second reconciliation is not complete, the control unit 29 may cause coins on the transport unit 25 to return to the cassette 30 such that the deemed storage amount of the cassette 30 is equal to the deemed storage amount before second reconciliation is started.

As described above, the coin handling apparatus 2 performs first reconciliation when the deemed storage amount of the cassette 30 satisfies the first predetermined condition. The coin handling apparatus 2 performs second reconciliation when the deemed storage amount of the cassette 30 satisfies the second predetermined condition. For this reason, at the time of performing first reconciliation and second reconciliation, it is possible to prevent mixture of recognized money and not-yet-recognized money in the cassette 30 regardless of the maximum storage amount of the cassette 30. Even when the number of pieces of money allowed to be concurrently transported by the transport unit 25 is not increased to remove limitations on the maximum storage amount of the cassette 30, it is possible to prevent mixture of recognized money and not-yet-recognized money in the cassette 30 at the time of first reconciliation and second reconciliation. For this reason, the size of the coin handling apparatus 2 does not need to be increased. Therefore, the coin handling apparatus 2 is capable of appropriately performing first reconciliation and second reconciliation of the cassette 30 regardless of the maximum storage amount of the cassette 30 without leading to an increase in the size of the coin handling apparatus 2.

In Embodiment 4, reconciliation on the first denomination-specific storage unit 241 may be configured to be performed when, for example, the deemed storage amount of the first denomination-specific storage unit 241 satisfies a predetermined condition. In this case, the first denomination-specific storage unit 241 corresponds to the first storage unit according to the present disclosure. The predetermined condition in this case may be that the deemed storage amount of the first denomination-specific storage unit 241 is less than or equal to the supportable amount of the transport unit 25.

The supportable amount of the transport unit 25 may be the amount of coins allowed to be concurrently supported in a third part path in the withdrawal transport path 33 and a fourth part path in the deposit transport path 32 (Condition A4). The third part path is a part from a dropped position (transport start position) of not-yet-recognized coins discharged from the first denomination-specific storage unit 241 to the feeding unit 31. The fourth part path is a part from the transport start position of not-yet-recognized coins fed out from the feeding unit 31 to the chute 271 leading to the first denomination-specific storage unit 241. The supportable amount of the transport unit 25 may be the amount of coins allowed to be held in the feeding unit 31 (Condition A2 described above). Furthermore, the supportable amount of the transport unit 25 may be a total amount of the amount of coins of Condition A4 and the amount of coins of Condition A2 (Condition A5). In this case as well, as in the case of the above-described reconciliation on the cassette 30, it is possible to prevent mixture of recognized money and not-yet-recognized money in the first denomination-specific storage unit 241 at the time of reconciliation.

### Embodiment 5

Next, Embodiment 5 will be described with reference to the attached drawings. In Embodiment 5, a banknote handling apparatus that is an example of the money handling apparatus will be described. For example, the banknote handling apparatus is used as a settlement machine that is installed at a shop.

### Configuration of Banknote Handling Apparatus

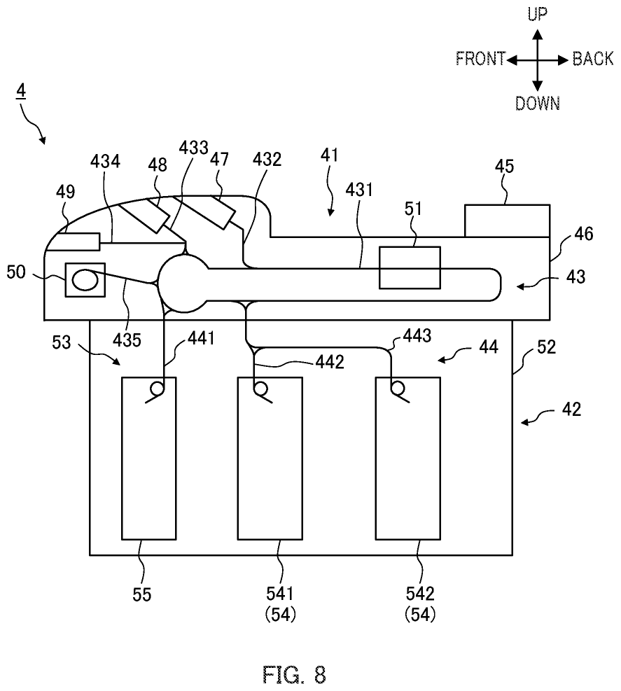

Initially, the configuration of the banknote handling apparatus will be described. FIG. 8 is a schematic diagram of the internal configuration of the banknote handling apparatus. In the following description, a front side is a side to which a clerk or a customer of a shop in which the banknote handling apparatus is installed faces, and a back side is a side opposite to the front side. A right-hand side is a right-hand side when viewed from the clerk or the customer, and a left-hand side is a side opposite to the right-hand side. An upper side is an upper side when viewed from the clerk or the customer, and a lower side is a side opposite to the upper side.

The banknote handling apparatus 4 shown in FIG. 8 performs handling on banknotes that are an example of money. For example, deposit, withdrawal, and reconciliation can be illustrated as handling on banknotes. The banknote handling apparatus 4 includes an upper-part handling unit 41, a lower-part safe unit 42, an upper transport unit 43, a lower transport unit 44, and a control unit 45. The handling unit 41 includes an upper-part casing 46. A deposit unit 47, a withdrawal unit 48, a rejecting unit 49, a temporary storage unit 50, and a recognition unit 51 are disposed in the upper-part casing 46.

The safe unit 42 is configured to include a safe casing 52, an attachment unit 53, and a recycling storage unit 54.

The deposit unit 47 is configured to be capable of depositing banknotes into the banknote handling apparatus 4. The withdrawal unit 48 is configured to be capable of withdrawing banknotes from the banknote handling apparatus 4. The rejecting unit 49 is configured to be capable of discharging banknotes not allowed to be deposited, as rejected banknotes.

The temporary storage unit 50 temporarily stores banknotes intended for deposit, for example, at the time of deposit. The temporary storage unit 50 is capable of feeding out the stored banknotes. The temporary storage unit 50 is a tape-type storage unit. The temporary storage unit 50 stores banknotes by taking up banknotes with a drum together with a tape.

The recognition unit 51 is disposed in a first transport path 431 (described later). The recognition unit 51 recognizes the denomination, authenticity, fitness, and the like of banknotes to be transported by the first transport path 431 and counts the banknotes separately by denomination.

The attachment unit 53 is, for example, provided at a front part inside the safe casing 52. A cassette 55 is detachably attached to the attachment unit 53. The cassette 55 is an example of the first storage unit according to the present disclosure. The cassette 55 includes a transport mechanism. The transport mechanism is configured to be capable of recycling banknotes by feeding banknotes from the outside of the cassette 55 to the inside of the cassette 55 and feeding banknotes from the inside of the cassette 55 to the outside of the cassette 55. For example, banknotes that cannot be stored in the recycling storage unit 54 because the recycling storage unit 54 is full (overflow banknotes) or change fund to refill the recycling storage unit 54 may be illustrated as banknotes to be stored in the cassette 55. Information indicating the deemed storage amount of the cassette 55 (the amount of banknotes deemed to be stored in the cassette 55) is stored in a management apparatus that manages the banknote handling apparatus 4. Information indicating the deemed storage amount of the cassette 55 may be stored in a memory unit of the banknote handling apparatus 4. Information indicating the deemed storage amount of the cassette 55 is updated based on a detection result of a sensor provided for the cassette 55 or a loading result of banknotes in a loading apparatus that loads the cassette 55 with banknotes.

The recycling storage unit 54 is, for example, provided at a back-side part with respect to the attachment unit 53 inside the safe casing 52. The recycling storage unit 54 is an example of the second storage unit according to the present disclosure. The recycling storage unit 54 includes a plurality of (two in Embodiment 5) denomination-specific storage units 541, 542 (hereinafter, which may be referred to as the first denomination-specific storage unit 541 and the second denomination-specific storage unit 542). The first denomination-specific storage unit 541 and the second denomination-specific storage unit 542, as in the case of the cassette 55, include a transport mechanism that feeds in and out banknotes to and from the first denomination-specific storage unit 541 and the second denomination-specific storage unit 542. Information on a deemed storage amount of the first denomination-specific storage unit 541 and a deemed storage amount of the second denomination-specific storage unit 542 (that is, the amount of banknotes deemed to be stored in the first denomination-specific storage unit 541 and the amount of banknotes deemed to be stored in the second denomination-specific storage unit 542) is stored in the management apparatus. Information indicating the deemed storage amount of the first denomination-specific storage unit 541 and the deemed storage amount of the second denomination-specific storage unit 542 may be stored in the memory unit of the banknote handling apparatus 4. Information indicating the deemed storage amount of the first denomination-specific storage unit 541 and the deemed storage amount of the second denomination-specific storage unit 542 is updated based on a detection result of a sensor provided for each of the first denomination-specific storage unit 541 and the second denomination-specific storage unit 542. A denomination of banknotes stored in the first denomination-specific storage unit 541 and a denomination of banknotes stored in the second denomination-specific storage unit 542 are set in advance.

The upper transport unit 43 and the lower transport unit 44 separate banknotes and transport the banknotes one by one in the banknote handling apparatus 4.

The upper transport unit 43 includes a first transport path 431, a second transport path 432, a third transport path 433, a fourth transport path 434, and a fifth transport path 435.

The first transport path 431 is configured in a loop shape. The first transport path 431 is capable of transporting banknotes in a clockwise direction and in a counter-clockwise direction in FIG. 8. The second transport path 432 connects the deposit unit 47 with the first transport path 431 and transports banknotes from the deposit unit 47 toward the first transport path 431. The third transport path 433 connects the withdrawal unit 48 with the first transport path 431 and transports banknotes from the first transport path 431 toward the withdrawal unit 48. The fourth transport path 434 connects the rejecting unit 49 with the first transport path 431 and transports banknotes from the first transport path 431 toward the rejecting unit 49. The fifth transport path 435 connects the temporary storage unit 50 with the first transport path 431. The fifth transport path 435 transports banknotes from the first transport path 431 toward the temporary storage unit 50 and also transports banknotes from the temporary storage unit 50 toward the first transport path 431.

The lower transport unit 44 includes a sixth transport path 441, a seventh transport path 442, and an eighth transport path 443.

The sixth transport path 441 connects the cassette 55 attached to the attachment unit 53 with the first transport path 431. The sixth transport path 441 transports banknotes from the first transport path 431 toward the cassette 55 and also transports banknotes from the cassette 55 toward the first transport path 431. The seventh transport path 442 connects the first denomination-specific storage unit 541 with the first transport path 431. The seventh transport path 442 transports banknotes from the first transport path 431 toward the first denomination-specific storage unit 541 and also transports banknotes from the first denomination-specific storage unit 541 toward the first transport path 431. The eighth transport path 443 connects the second denomination-specific storage unit 542 with the seventh transport path 442. The eighth transport path 443 transports banknotes from the seventh transport path 442 toward the second denomination-specific storage unit 542 and also transports banknotes from the second denomination-specific storage unit 542 toward the first transport path 431 via the seventh transport path 442.

The control unit 45 controls the overall operation of the banknote handling apparatus 4. The control unit 45 controls deposit of banknotes a customer pays at the time of settlement of goods. The control unit 45 controls withdrawal of coins at the time of settlement of goods.

When the deemed storage amount of the cassette 55 satisfies a predetermined condition, the control unit 45 performs reconciliation for confirming the inventory amount of the cassette 55 by the recognition unit 51′s recognizing banknotes in the cassette 55. The predetermined condition is that the deemed storage amount of the cassette 55 is less than or equal to the amount of coins allowed to be concurrently positioned in a place other than the cassette 55 at the time of performing reconciliation. The predetermined condition of Embodiment 5 may be that the deemed storage amount of the cassette 55 is less than or equal to the amount of banknotes allowed to be concurrently transported in the first transport path 431 (supportable amount) (Condition D). The predetermined condition may be that the deemed storage amount of the cassette 55 is less than or equal to the amount of banknotes allowed to be stored in the temporary storage unit 50 (second storage unit) (storable amount) (Condition E). The predetermined condition may be that the deemed storage amount of the cassette 55 is less than or equal to a total amount of the supportable amount of the first transport path 431 and the storable amount of the temporary storage unit 50 (Condition F).

For example, every set time interval, time when set time comes, time when a clerk issues instructions, or time when a situation in which it is not possible to confirm the inventory amount of the cassette 55 may be illustrated as timing to determine whether the deemed storage amount of the cassette 55 satisfies the predetermined condition. As in the case of Embodiment 4, for example, a situation in which the cassette 55 is detached and attached again, or a situation in which there occurs a jam of banknotes to be transported to the cassette 55 at the time of deposit or a jam of banknotes discharged from the cassette 55 may be illustrated as a situation in which it is not possible to confirm the inventory amount of the cassette 55.

### Operation of Banknote Handling Apparatus

Next, reconciliation on the cassette 55 will be described as the operation of the banknote handling apparatus 4.

The control unit 45 determines at the above-described timing whether the deemed storage amount of the cassette 55 satisfies the predetermined condition. When the control unit 45 determines that the deemed storage amount of the cassette 55 satisfies the predetermined condition, the control unit 45 performs reconciliation on the cassette 55 by controlling the upper transport unit 43, the lower transport unit 44, the temporary storage unit 50, and the cassette 55, for example, as follows.

Initially, the control unit 45 controls the upper transport unit 43, the lower transport unit 44, the temporary storage unit 50, and the cassette 55 such that banknotes in the storable amount of the temporary storage unit 50 are transported to the temporary storage unit 50 as recognized banknotes by discharging banknotes in the cassette 55 and transporting the banknotes in a counter-clockwise direction in FIG. 8 with the first transport path 431 and the remaining banknotes are positioned on the first transport path 431. Here, if such control is executed in a state where the deemed storage amount of the cassette 55 does not satisfy the predetermined condition, all the banknotes stored in the cassette 55 may be not allowed to be positioned in the temporary storage unit 50 or on the first transport path 431 in a state where the cassette 55 is empty. In Embodiment 5, the above-described control is executed when the deemed storage amount of the cassette 55 satisfies the predetermined condition. Therefore, even when the predetermined condition is any one of the above-described Condition D, Condition E, and Condition F, all the banknotes stored in the cassette 55 are allowed to be positioned in the temporary storage unit 50 or on the first transport path 431 in a state where the cassette 55 is empty.

Then, the control unit 45 causes the banknotes positioned in the temporary storage unit 50 or on the first transport path 431 to return to the cassette 55 in storage order as that before being discharged from the cassette 55. For example, the control unit 45 controls the upper transport unit 43, the lower transport unit 44, and the cassette 55 such that banknotes on the first transport path 431 are transported in a clockwise direction in FIG. 8 and recognized by the recognition unit 51 and then stored in the cassette 55 as recognized banknotes. When all the banknotes on the first transport path 431 are stored in the cassette 55, the control unit 45 controls the temporary storage unit 50, the upper transport unit 43, the lower transport unit 44, and the cassette 55 such that banknotes in the temporary storage unit 50 are transported in a clockwise direction in FIG. 8 by the first transport path 431 and recognized by the recognition unit 51 and then stored in the cassette 55 as recognized banknotes. Then, the control unit 45 causes the management apparatus to store the reconciliation result.

As described above, the banknote handling apparatus 4 performs reconciliation when the deemed storage amount of the cassette 55 satisfies the predetermined condition. For this reason, at the time of performing reconciliation, it is possible to position all the banknotes stored in the cassette 55 in the temporary storage unit 50 or on the first transport path 431 in a state where the cassette 55 is empty regardless of the maximum storage amount of the cassette 55. Even when the number of banknotes allowed to be concurrently transported by the first transport path 431 is not increased to remove limitations on the maximum storage amount of the cassette 55, banknotes stored in the cassette 55 can be positioned in the temporary storage unit 50 or on the first transport path 431 in a state where the cassette 55 is empty. For this reason, the size of the banknote handling apparatus 4 does not need to be increased. Therefore, the banknote handling apparatus 4 is capable of appropriately performing reconciliation on the cassette 55 regardless of the maximum storage amount of the cassette 55 without leading to an increase in the size of the banknote handling apparatus 4.

In Embodiment 5, reconciliation on the first denomination-specific storage unit 541 may be configured to be performed when, for example, the deemed storage amount of the first denomination-specific storage unit 541 satisfies a predetermined condition (any one of Conditions D to F). In this case, the first denomination-specific storage unit 541 corresponds to the first storage unit according to the present disclosure. In this case as well, as in the case of the above-described reconciliation on the cassette 55, banknotes stored in the first denomination-specific storage unit 541 are once positioned in the temporary storage unit 50 or on the first transport path 431 in a state where the first denomination-specific storage unit 541 is empty and then these banknotes may be sequentially recognized by the recognition unit 51.

### Variations of Embodiments

The present disclosure is, of course, not limited to those described in the embodiments illustrated above, and various modifications may be added without departing from the purport. The above-described embodiments and variations described below may be combined in any way within an applicable range.

For example, in Embodiment 4, the control unit 29 may cause a notification unit to notify that the deemed storage amount of the cassette 30 satisfies the predetermined condition (the first predetermined condition or the second predetermined condition). For example, a method of displaying notification on the operation display unit 28 with a character, a symbol, a color, or combinations of them or a method of providing notification by sound with a speaker may be illustrated as the notification method. In this case, the control unit 29 may start reconciliation when the control unit 29 receives instructions for starting reconciliation (first reconciliation or second reconciliation) through the operation display unit 28. With such a configuration, a clerk is able to perform reconciliation on the cassette 30 at timing desired by the clerk after the deemed storage amount of the cassette 30 satisfies the predetermined condition. Similarly, in Embodiments 1 to 3, and 5, notification that the deemed storage amount of the first storage unit 10 or the cassette 55 satisfies the predetermined condition may be provided by the notification unit or reconciliation may be configured to be started when instructions from the input unit are received.

In Embodiment 4, the control unit 29 may determine whether the deemed storage amount of the cassette 30 satisfies the predetermined condition, based on the denomination of coins stored in the cassette 30. For example, the control unit 29 may determine whether the deemed storage amount of the cassette 30 satisfies the predetermined condition, based on the size of coins, corresponding to the denomination of coins stored in the cassette 30. When it is determined whether themed storage amount of the cassette 30 satisfies the predetermined condition, based on the size of coins, the supportable amount of the transport unit 25, for example, reduces as the size of coins increases. Similarly, in Embodiments 1 to 3, and 5, it may be determined whether the deemed storage amount of the first storage unit 10 or the cassette 55 satisfies the predetermined condition, based on the denomination of money stored in the first storage unit 10 or the cassette 55.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A money handling apparatus comprising:
a first storage unit that stores money and discharges the stored money;
a transport unit that transports money;
a recognition unit that recognizes money; and
a control unit that performs reconciliation for confirming a storage amount of money in the first storage unit by the recognition unit's recognizing money that is discharged from the first storage unit and transported by the transport unit, wherein
the control unit performs the reconciliation when a deemed storage amount that is an amount of money deemed to be stored in the first storage unit satisfies a predetermined condition, and
the predetermined condition is that the deemed storage amount is less than or equal to an amount of the money allowed to be concurrently positioned in a place other than the first storage unit in the money handling apparatus.

2. The money handling apparatus according to claim 1, wherein
the transport unit comprises:
a transport path that transports the money; and
a feeding unit that temporarily holds a plurality of pieces of money and feeds out the held pieces of money one by one.

3. The money handling apparatus according to claim 1, wherein
the predetermined condition is that the deemed storage amount is less than or equal to an amount of money allowed to be concurrently supported by the transport unit.

4. The money handling apparatus according to claim 1, wherein
the control unit controls the transport unit such that the money recognized by the recognition unit is returned to the first storage unit during performing the reconciliation.

5. The money handling apparatus according to claim 1, further comprising
a second storage unit that stores the money recognized by the recognition unit, wherein
the control unit controls the transport unit such that the money is transported to the second storage unit, when the money recognized by the recognition unit is target money to be stored in the second storage unit during performing the reconciliation.

6. The money handling apparatus according to claim 5, wherein
the second storage unit comprises a plurality of denomination-specific storage units that stores the money by denomination, and
the control unit controls the transport unit such that the money recognized by the recognition unit is transported to the denomination-specific storage unit corresponding to the denomination of the money.

7. The money handling apparatus according to claim 5, wherein
the predetermined condition is that the deemed storage amount is less than or equal to an amount of money allowed to be stored in the second storage unit at time of determining whether the deemed storage amount satisfies the predetermined condition.

8. The money handling apparatus according to claim 5, wherein
the predetermined condition is that the deemed storage amount is less than or equal to a total amount of an amount of money allowed to be concurrently supported by the transport unit and an amount of money allowed to be stored in the second storage unit at time of determining whether the deemed storage amount satisfies the predetermined condition.

9. The money handling apparatus according to claim 5, wherein
the control unit controls the transport unit such that the money recognized by the recognition unit is returned to the first storage unit, when the money recognized by the recognition unit is not allowed to be stored in the second storage unit.

10. The money handling apparatus according to claim 4, wherein
the control unit determines that the reconciliation has been terminated in an uncompleted state, when the money recognized by the recognition unit has returned to the first storage unit before all the money in the first storage unit is discharged.

11. The money handling apparatus according to claim 9, wherein
the control unit determines that the reconciliation has been terminated in an uncompleted state, when the money recognized by the recognition unit has returned to the first storage unit before all the money in the first storage unit is discharged.

12. The money handling apparatus according to claim 1, further comprising:
a notification unit that notifies that the deemed storage amount satisfies the predetermined condition.

13. The money handling apparatus according to claim 1, further comprising:
an input unit that allows entry of an instruction for starting the reconciliation, wherein
the control unit starts the reconciliation when the control unit receives the instruction from the input unit.

14. The money handling apparatus according to claim 1, wherein
the control unit determines whether the deemed storage amount satisfies the predetermined condition, based on a denomination of the money stored in the first storage unit.

15. A money handling method that is executed by a money handling apparatus comprising a first storage unit that stores money and discharges the stored money, and a recognition unit that recognizes money, the money handling method comprising:
performing, by the money handling apparatus, reconciliation for confirming a storage amount of money in the first storage unit by recognizing money discharged from the first storage unit with the recognition unit, when a deemed storage amount that is an amount of money deemed to be stored in the first storage unit satisfies a predetermined condition, wherein
the predetermined condition is that the deemed storage amount is less than or equal to an amount of the money allowed to be concurrently positioned in a place other than the first storage unit in the money handling apparatus.
